(19) United States
(12) Patent Application Publication
(10) Pub. No.: US 2024/0406760 A1
(43) Pub. Date: Dec. 5, 2024

(54) Minimization of Drive Testing for Non-Terrestrial Networks

(71) Applicant: Telefonaktiebolaget LM Ericsson (publ), Stockholm (SE)

(72) Inventors: Pradeepa Ramachandra, Linköping (SE); Muhammad Ali Kazmi, Sundbyberg (SE); Helka-Liina Määttänen, Espoo (FI); Marco Belleschi, Solna (SE); Ming Li, Stockholm (SE)

(21) Appl. No.: 18/698,926

(22) PCT Filed: Oct. 7, 2022
(86) PCT No.: PCT/SE2022/050904

§ 371 Date: Apr. 5, 2024

Related U.S. Application Data
(60) Provisional application No. 63/254,014, filed on Oct. 8, 2021.

(51) Int. Cl. H04W 24/02; H04W 24/10; H04W 84/06

(52) U.S. Cl. CPC H04W 24/02; H04W 24/10; H04W 84/06

(57) ABSTRACT

A wireless communication device (12) collects minimization of drive test, MDT, measurements. The wireless communication device (12) transmits an MDT measurement report (14) that reports the MDT measurements. The content (14C) of the MDT measurement report (14) depends on whether or not the MDT measurements were collected when the wireless communication device (12) was being served by, had been served by, or was near a cell (20A) of a non-terrestrial network, NTN (10A).

### TECHNICAL FIELD

The present application relates generally to minimization of drive testing, and relates more particularly to minimization of drive testing for non-terrestrial networks.

### BACKGROUND

Traditionally, a wireless communication network operator conducted drive tests dedicated to collecting radio measurements for optimizing power, antenna locations, antenna tilts, and other parameters in the network that impact coverage and performance. Using drive tests for network optimization thereby proved costly and burdensome.

So-called minimization of drive test (MDT) measurements minimize the drive tests that a wireless communication network operator must conduct for network optimization. MDT in this regard exploits subscribers' own wireless communication devices for performing the radio measurements, relieving the need for the operator to itself conduct drive tests. The MDT measurements may for example include radio measurements and location measurements, usable for analyzing radio coverage and performance in different locations.

Challenges nonetheless exist in accomplishing MDT efficiency, especially as operators begin to supplement their terrestrial networks with non-terrestrial networks (NTNs).

### SUMMARY

According to some embodiments herein, a wireless communication device tailors its MDT measurement report for NTNs, e.g., so that the content of the MDT measurement report is particularly usable for optimizing NTN coverage and/or performance, and/or for optimizing terrestrial network parameters that impact mobility to or from NTNs. In these and other embodiments, then, the content of the MDT measurement report depends on whether or not the reported MDT measurements were collected when the wireless communication device was being served by, had been served by, or was near a cell of an NTN. With the content of the MDT measurement report tailored in this way, some embodiments increase MDT measurement collection and reporting efficiency for NTN optimization and/or report MDT measurements usable for identifying coverage transition patterns between NTN cells and terrestrial network cells.

More particularly, embodiments herein include a method performed by a wireless communication device. The method comprises collecting minimization of drive test, MDT, measurements, and transmitting an MDT measurement report that reports the MDT measurements. In this case, the content of the MDT measurement report depends on whether or not the MDT measurements were collected when the wireless communication device was being served by, had been served by, or was near a cell of a non-terrestrial network, NTN.

In some embodiments, the content of the MDT measurement report depends on whether or not the MDT measurements were collected when the wireless communication device was being served by a cell of an NTN.

In some embodiments, the MDT measurement report includes an indicator whose value indicates whether or not a cell serving the wireless communication device when the MDT measurements were collected is a cell of an NTN.

In some embodiments, the content of the MDT measurement report depends on whether or not the MDT measurements were collected when the wireless communication device was near a cell of an NTN.

In some embodiments, the MDT measurement report includes an indicator whose value indicates whether or not a neighbor cell of a cell serving the wireless communication device when the MDT measurements were collected is a cell of an NTN.

In some embodiments, the MDT measurement report includes an indicator whose value indicates whether or not any neighbor cell of a cell serving the wireless communication device when the MDT measurements were collected is a cell of an NTN.

In some embodiments, the MDT measurement report includes an indicator whose value indicates whether or not the wireless communication device had coverage from a cell of an NTN when the MDT measurements were collected from a cell of a terrestrial network. Alternatively, the MDT measurement report includes an indicator whose value indicates whether or not the wireless communication device had coverage from a cell of a terrestrial network when the MDT measurements were collected from a cell of an NTN.

In some embodiments, the content of the MDT measurement report depends on whether or not the MDT measurements were collected when the wireless communication device had been served by a cell of an NTN. In one or more of these embodiments, the content of the MDT measurement report includes an indicator indicating whether, when the MDT measurements were collected, a last serving cell of the wireless communication device before the wireless communication device entered an any cell selection state is a cell of an NTN.

In some embodiments, the content of the MDT measurement report includes an indicator indicating whether, when the MDT measurements were collected, a cell that first served the wireless communication device after the wireless communication device exited an any cell selection state is a cell of an NTN.

In some embodiments, when the MDT measurements were collected when the wireless communication device was served by a cell of an NTN, the MDT measurement report always includes location information for the wireless communication device.

In some embodiments, the MDT measurements were collected when the wireless communication device was being served by, had been served by, or was near a cell of an NTN. In this case, the MDT measurement report reports a duration for which the wireless communication device was, has been, or is predicted to be in coverage of a satellite serving the cell. Additionally or alternatively, the MDT measurement report reports a type of cell ranking criterion used by the wireless communication device for cell reselecting in the NTN. Additionally or alternatively, the MDT measurement report reports one or more characteristics of a satellite serving the cell. In one or more of these embodiments, the one or more characteristics include one or more of a speed or velocity of the satellite, a position of the satellite, an orbit of the satellite, a propagation delay between the wireless communication device and the satellite, a timing advance for the satellite.

In some embodiments, collecting MDT measurements comprises logging MDT measurements, and the MDT measurement report is a logged MDT measurement report that reports the logged MDT measurements. In one or more of these embodiments, logging MDT measurements comprises logging MDT measurements while the wireless communication device is in a radio resource control, RRC idle mode or an RRC inactive mode, and transmitting the MDT measurement report comprises transmitting the MDT measurement report after transitioning from the RRC idle mode or the RRC inactive mode to an RRC connected state.

Other embodiments herein include a method performed by a network node configured for use in a wireless communication network. The method comprises receiving a minimization of drive test, MDT, measurement report that reports MDT measurements by a wireless communication device, wherein the content of the MDT measurement report depends on whether or not the MDT measurements were collected when the wireless communication device was being served by, had been served by, or was near a cell of a non-terrestrial network, NTN.

In some embodiments, the content of the MDT measurement report depends on whether or not the MDT measurements were collected when the wireless communication device was being served by a cell of an NTN.

In some embodiments, the MDT measurement report includes an indicator whose value indicates whether or not a cell serving the wireless communication device when the MDT measurements were collected is a cell of an NTN.

In some embodiments, the content of the MDT measurement report depends on whether or not the MDT measurements were collected when the wireless communication device was near a cell of an NTN.

In some embodiments, the MDT measurement report includes an indicator whose value indicates whether or not a neighbor cell of a cell serving the wireless communication device when the MDT measurements were collected is a cell of an NTN.

In some embodiments, the MDT measurement report includes an indicator whose value indicates whether or not any neighbor cell of a cell serving the wireless communication device when the MDT measurements were collected is a cell of an NTN.

In some embodiments, the MDT measurement report includes an indicator whose value indicates whether or not the wireless communication device had coverage from a cell of an NTN when the MDT measurements were collected from a cell of a terrestrial network. Alternatively, the MDT measurement report includes an indicator whose value indicates whether or not the wireless communication device had coverage from a cell of a terrestrial network when the MDT measurements were collected from a cell of an NTN.

In some embodiments, the content of the MDT measurement report depends on whether or not the MDT measurements were collected when the wireless communication device had been served by a cell of an NTN. In one or more of these embodiments, the content of the MDT measurement report includes an indicator indicating whether, when the MDT measurements were collected, a last serving cell of the wireless communication device before the wireless communication device entered an any cell selection state is a cell of an NTN.

In some embodiments, the content of the MDT measurement report includes an indicator indicating whether, when the MDT measurements were collected, a cell that first served the wireless communication device after the wireless communication device exited an any cell selection state is a cell of an NTN.

In some embodiments, when the MDT measurements were collected when the wireless communication device was served by a cell of an NTN, the MDT measurement report always includes location information for the wireless communication device.

In some embodiments, the MDT measurements were collected when the wireless communication device was being served by, had been served by, or was near a cell of an NTN. In this case, the MDT measurement report reports a duration for which the wireless communication device was, has been, or is predicted to be in coverage of a satellite serving the cell. Additionally or alternatively, the MDT measurement report reports a type of cell ranking criterion used by the wireless communication device for cell reselecting in the NTN. Additionally or alternatively, the MDT measurement report reports one or more characteristics of a satellite serving the cell. In one or more of these embodiments, the one or more characteristics include one or more of a speed or velocity of the satellite, a position of the satellite, an orbit of the satellite, a propagation delay between the wireless communication device and the satellite, a timing advance for the satellite.

In some embodiments, the MDT measurement report is a logged MDT measurement report that reports MDT measurements as logged by the wireless communication device. In one or more of these embodiments, the MDT measurement report is a logged MDT measurement report that reports MDT measurements as logged by the wireless communication device in a radio resource control, RRC idle mode or an RRC inactive mode, and the MDT measurement report is received from the wireless communication device while the wireless communication device is in an RRC connected state.

In some embodiments, the method further comprises building a coverage map from the received MDT measurement report.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication device, a terrestrial network, and a non-terrestrial network according to some embodiments.

FIG. 2 is a block diagram of an architecture of a satellite network with bent pipe transponders according to some embodiments.

FIG. 3 is a timing diagram of MDT logging according to some embodiments.

FIG. 4 is a logic flow diagram of a method performed by a wireless communication device according to some embodiments.

FIG. 5 is a logic flow diagram of a method performed by a network node according to some embodiments.

FIG. 6 is a block diagram of a wireless communication device according to some embodiments.

FIG. 7 is a block diagram of a network node according to some embodiments.

FIG. 8 is a block diagram of a communication system in accordance with some embodiments

FIG. 9 is a block diagram of a user equipment according to some embodiments.

FIG. 10 is a block diagram of a network node according to some embodiments.

FIG. 11 is a block diagram of a host according to some embodiments.

FIG. 12 is a block diagram of a virtualization environment according to some embodiments.

FIG. 13 is a block diagram of a host communicating via a network node with a UE over a partially wireless connection in accordance with some embodiments.

### DETAILED DESCRIPTION

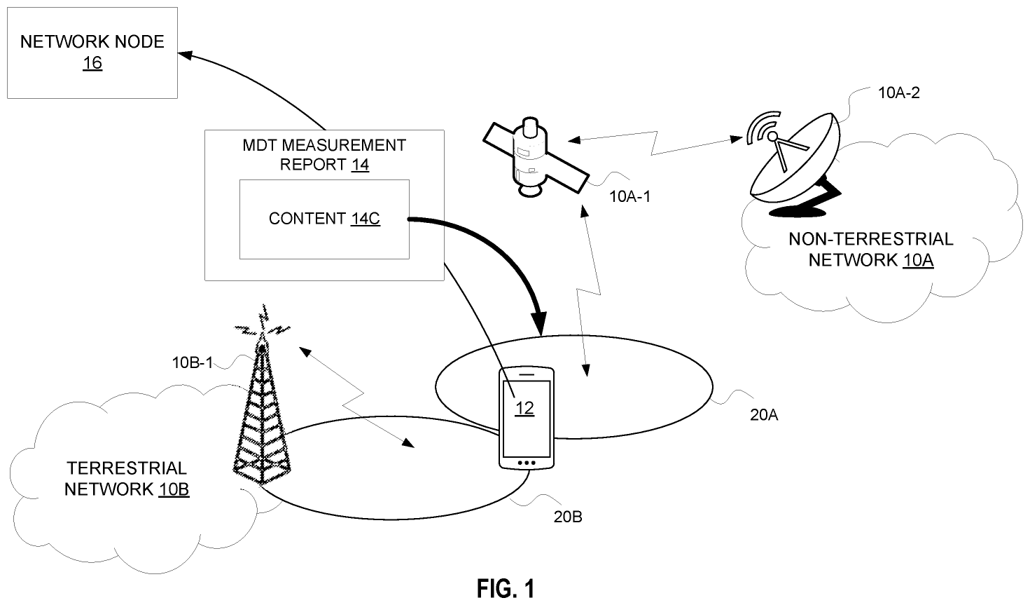

FIG. 1 shows a wireless communication device 12 according to some embodiments. As shown, the wireless communication device 12 collects minimization of drive test (MDT) measurements and transmits an MDT measurement report 14 that reports the MDT measurements. The MDT measurements may for example include radio measurements and location measurements, e.g., usable for analyzing radio coverage and performance in different locations.

Notably, the content 14C of the MDT measurement report 14 depends on whether or not the MDT measurements were collected when the wireless communication device 12 was being served by, had been served by, or was near a cell of a non-terrestrial network, NTN. FIG. 1 depicts one such NTN 10A, which provides wireless communication service via one or more satellites 10A-1, possibly in conjunction with one or more gateways 10A-2. This contrasts with a terrestrial network 10B, which provides wireless communication service via one or more base stations 10B-1. In some embodiments, the wireless communication device 12 reports the MDT measurement report 14 to a network node 16, which may be deployed in the NTN 10A or terrestrial network 10B. Regardless, with the content 14C of the MDT measurement report 14 specific to NTNs in this way, some embodiments increase MDT measurement collection and reporting efficiency for NTN optimization and/or report MDT measurements usable for identifying coverage transition patterns between NTN cells and terrestrial network cells.

More particularly, in some embodiments, the content 14C of the MDT measurement report 14 depends on whether or not the MDT measurements were collected when the wireless communication device 12 was being served by a cell 20A of an NTN 10A. In these and other embodiments, the MDT measurement report 14 may include an indicator whose value indicates whether or not a cell serving the wireless communication device 12 when the MDT measurements were collected is a cell 20A of an NTN 10A.

Alternatively or additionally, in some embodiments, the content 14C of the MDT measurement report 14 depends on whether or not the MDT measurements were collected when the wireless communication device 12 was near a cell 20A of an NTN 10A. For example, in these and other embodiments, the MDT measurement report 14 may include an indicator whose value indicates whether or not a neighbor cell of a cell serving the wireless communication device 12 when the MDT measurements were collected is a cell 20A of an NTN 10A. As another example, the MDT measurement report 14 may include an indicator whose value indicates whether or not any neighbor cell of a cell serving the wireless communication device 12 when the MDT measurements were collected is a cell 20A of an NTN 10A.

In still other embodiments, the MDT measurement report 14 may include an indicator whose value indicates whether or not the wireless communication device 12 had coverage from a cell 20A of an NTN 10A when the MDT measurements were collected from a cell of a terrestrial network 10B. In other embodiments, the MDT measurement report 14 may include an indicator whose value indicates whether or not the wireless communication device 12 had coverage from a cell of a terrestrial network 10B when the MDT measurements were collected from a cell 20B of an NTN 10A.

In some embodiments, the content 14C of the MDT measurement report 14 depends on whether or not the MDT measurements were collected when the wireless communication device 12 had been served by a cell 20A of an NTN 10A. In one embodiment, for example, the content 14C of the MDT measurement report 14 includes an indicator indicating whether, when the MDT measurements were collected, a last serving cell of the wireless communication device 12 before the wireless communication device 12 entered an any cell selection state is a cell 20A of an NTN 10A.

In still other embodiments, the content 14C of the MDT measurement report 14 includes an indicator indicating whether, when the MDT measurements were collected, a cell that first served the wireless communication device 12 after the wireless communication device 12 exited an any cell selection state is a cell 20A of an NTN 10A.

Alternatively or additionally, when the MDT measurements were collected when the wireless communication device 12 was served by a cell 20A of an NTN 10A, the MDT measurement report may always include location information for the wireless communication device 12.

In some embodiments, the MDT measurements were collected when the wireless communication device 12 was being served by, had been served by, or was near a cell 20A of an NTN 10A. In this case, the MDT measurement report 14 may report (i) a duration for which the wireless communication device 12 was, has been, or is predicted to be in coverage of a satellite 10A-1 serving the cell 20A; and/or (ii) a type of cell ranking criterion used by the wireless communication device 12 for cell reselecting in the NTN 10A; and/or (iii) one or more characteristics of a satellite 10A-1 serving the cell 20A. In one such embodiment, the one or more characteristics include one or more of a speed or velocity of the satellite 10A-1, a position of the satellite 10A-1, an orbit of the satellite 10A-1, a propagation delay between the wireless communication device 12 and the satellite 10A-1, and/or a timing advance for the satellite 10A-1.

Note that the MDT measurement report 14 may report logged MDT or immediate MDT measurement results, e.g., as specified by 3GPP. With regard to logged MDT, the MDT measurement report 14 may be transmitted while the wireless communication device 12 is in a radio resource control (RRC) connected mode, but report MDT measurements that the wireless communication device 12 logged while the wireless communication device 12 was in a radio resource control (RRC) idle mode or an RRC inactive mode. By contrast, with regard to immediate MDT, the MDT measurement report 14 may report MDT measurements that the wireless communication device 12 collected while the wireless communication device 12 is in an RRC connected mode.

Some embodiments herein are applicable to NTNs as specified by the 3rd Generation Partnership Project (3GPP), where the wireless communication device 12 in FIG. 1 may be exemplified as a user equipment (UE). A satellite network or satellite-based mobile network may also be called a non-terrestrial network (NTN). On the other hand, a mobile network with base stations on the group may also be called a terrestrial network (TN) or non-NTN network. A satellite within NTN may be called an NTN node, NTN satellite, satellite node or simply a satellite.

In some embodiments, a satellite radio access network may include the following components: (i) a satellite that refers to a space-borne platform; (ii) an earth-based gateway that connects the satellite to a base station or a core network, depending on the choice of architecture; (iii) a feeder link that refers to the link between a gateway and a satellite; (iv) an access link that refers to the link between a satellite and a user equipment (UE).

Depending on the orbit altitude, a satellite in some embodiments may be categorized as low earth orbit (LEO), medium earth orbit (MEO), or geostationary earth orbit (GEO) satellite. LEO has typical heights ranging from 250-1,500 km, with orbital periods ranging from 90-120 minutes. MEO has typical heights ranging from 5,000-25,000 km, with orbital periods ranging from 3-15 hours. And GEO has a typical height at about 35,786 km, with an orbital period of 24 hours.

The significant orbit height means that satellite systems are characterized by a path loss that is significantly higher than what is expected in terrestrial networks. To overcome the pathloss it is often required that the access and feeder links are operated in line of sight conditions, and that the UE is equipped with an antenna offering high beam directivity.

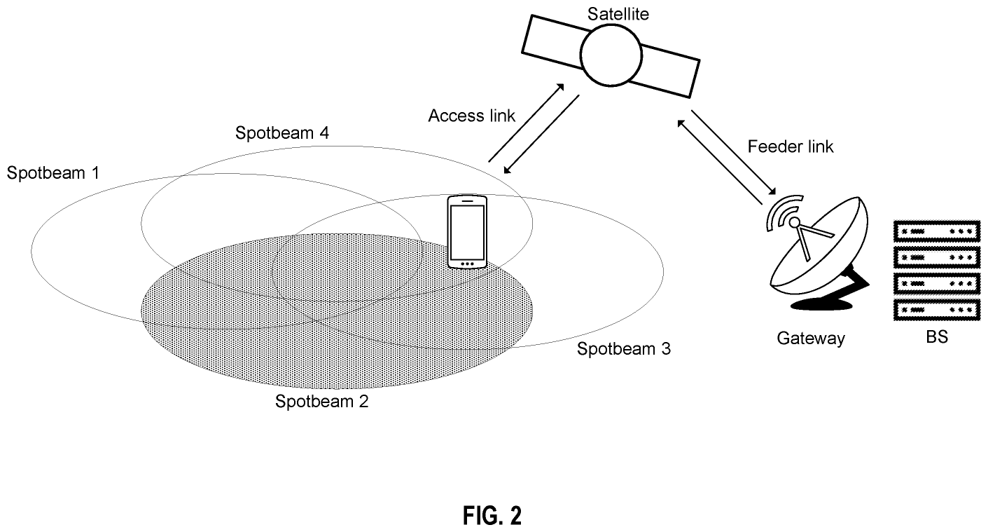

A communication satellite in some embodiments generates several beams over a given area. The footprint of a beam may be in an elliptic shape, which has been traditionally considered as a cell. The footprint of a beam is also often referred to as a spotbeam. The spotbeam may move over the earth surface with the satellite movement or may be earth fixed with some beam pointing mechanism used by the satellite to compensate for its motion. The size of a spotbeam depends on the system design, which may range from tens of kilometers to a few thousands of kilometers. FIG. 2 shows an example architecture of a satellite network with bent pipe transponders according to some embodiments.

An NTN beam may in comparison to the beams observed in a terrestrial network be very wide and cover an area outside of the area defined by the served cell. Beams covering adjacent cells will overlap and cause significant levels of intercell interference. To overcome the large levels of interference, one approach is an NTN to configure different cells with different carrier frequencies and polarization modes.

Propagation delay is an important aspect of satellite communications that is different from the delay expected in a terrestrial mobile system. For a bent pipe satellite network, the round-trip delay may, depending on the orbit height, range from tens of ms in the case of LEO satellites to several hundreds of ms for GEO satellites. As a comparison, the round-trip delays in terrestrial cellular networks are typically below 1 ms.

The distance between the UE and a satellite can vary significantly, depending on the position of the satellite and thus the elevation angle ε seen by the UE. Assuming circular orbits, the minimum distance is realized when the satellite is directly above the UE (ε=90°), and the maximum distance when the satellite is at the smallest possible elevation angle. Table 1 shows the distances between satellite and UE for different orbital heights and elevation angles together with the one-way propagation delay and the maximum propagation delay difference (the difference from the propagation delay at ε=90°). Note that this table assumes a regenerative payload architecture. For the transparent payload case, the propagation delay between gateway and satellite needs to be considered as well, unless the base station corrects for that.

TABLE 1
Propagation delay for different orbital heights and elevation angles.

| | | Distance | One-way | Propagation |
|---|---|---|---|---|
| Orbital | Elevation | UE <-> | propagation | delay |
| height | angle | satellite | delay | difference |
| 600 km | 90° | 600 km | 2.0 ms | — |
| | 30° | 1075 km | 3.6 ms | 1.6 ms |
| | 10° | 1932 km | 6.4 ms | 4.4 ms |
| 1200 km | 90° | 1200 km | 4.0 ms | — |
| | 30° | 1999 km | 6.7 ms | 2.7 ms |
| | 10° | 3131 km | 10.4 ms | 6.4 ms |
| 35786 km | 90° | 35786 km | 119.4 ms | — |
| | 30° | 38609 km | 128.8 ms | 9.4 ms |
| | 10° | 40581 km | 135.4 ms | 16.0 ms |

The propagation delay may also be highly variable due to the high velocity of the LEO and MEO satellites and change in the order of 10-100 μs every second, depending on the orbit altitude and satellite velocity.

To handle the timing and frequency synchronization in a New Radio (NR) or Long Term Evolution (LTE) based NTN, a promising technique is to equip each device with a Global Navigation Satellite System (GNSS) receiver. The GNSS receiver allows a device to estimate its geographical position. In one example, an NTN gNB carried by a satellite broadcasts its ephemeris data (i.e., data that informs the UE about the satellite's position, velocity, and orbit) to a GNSS equipped UE. The UE can then determine the propagation delay, the delay variation rate, the Doppler shift and its variation rate, based on its own location (obtained through GNSS measurements) and the satellite location and movement (derived from the ephemeris data).

The GNSS receiver also allows a device to determine a time reference (e.g., in terms of Coordinated Universal Time (UTC)) and frequency reference. This can also be used to handle the timing and frequency synchronization in a NR or LTE based NTN. In a second example, an NTN gNB carried by a satellite broadcasts its timing (e.g. in terms of a Coordinated Universal Time (UTC) timestamp) to a GNSS equipped UE. The UE can then determine the propagation delay, the delay variation rate, the Doppler shift and its variation rate based on its time/frequency reference (obtained through GNSS measurements) and the satellite timing and transmit frequency.

The UE may use this knowledge to compensate its UL transmissions for the propagation delay and Doppler effect.

The 3GPP release 17 SID on NB-IoT and LTE-M for NTN supports this observationError! Reference source not found.:
“GNSS capability in the UE is taken as a working assumption in this study for both NB-IoT and eMTC devices. With this assumption, UE can estimate and pre-compensate timing and frequency offset with sufficient accuracy for UL transmission. Simultaneous GNSS and NTN NB-IoT/eMTC operation is not assumed.”
Furthermore, in the NTN work item and IoT NTN study item for 3GPP release 17, GNSS capability is assumed, i.e., it is assumed that a NTN capable UE also is GNSS capable and GNSS measurements at the UEs are essential for the operation of the NTN.T

### Minimization of Drive Tests (MDT)

Some embodiments herein are applicable to MDT as specified by 3GPP. MDT was standardized for NR in Rel-16 to reduce the amount of drive tests performed manually. It is a UE-assisted framework where network measurements are collected by both IDLE/INACTIVE and RRC Connected UE(s) in order to aid the network in gathering valuable information. Some embodiments herein are applicable in this regard to MDT as otherwise specified for both LTE and NR in TS 37.320 v16.6.0.

In general, there are two types of MDT measurement collection, i.e., Logged MDT and Immediate MDT.

### Logged MDT

A UE in RRC_IDLE/RRC_INACTIVE state is configured to perform periodic and event-triggered MDT logging after receiving the MDT configurations from the network. The UE shall report the downlink (DL) pilot strength measurements (reference signal received power (RSRP)/reference signal received quality (RSRQ)) together with time information, detailed location information if available, and wireless local area network (WLAN), Bluetooth to the network via using the UE information framework when it is in RRC_CONNECTED state. The DL pilot strength measurement of Logged MDT is collected based on the existing measurements required for cell reselection purposes, without requiring the UE to perform additional measurements.

TABLE 1
The measurement logging for Logged MDT

| MDT | | |
|---|---|---|
| mode | RRC states | Measurement quantities |
| Logged | RRC_IDLE/ | RSRP and RSRQ of the |
| MDT | RRC_INACTIVE | serving cell and available |
| | | UE measurements for |
| | | intra-frequency/inter- |
| | | frequency/inter-RAT, |
| | | time stamp and detailed |
| | | location information if available. |

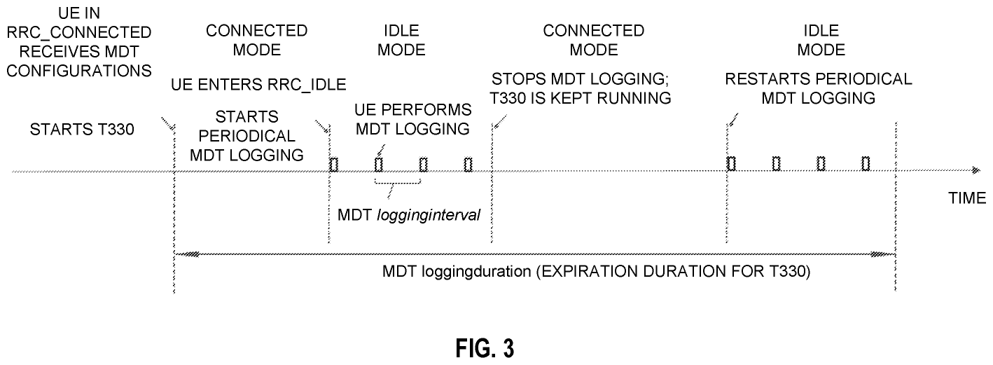

In some embodiments, for Periodical Logged MDT, the UE receives the MDT configurations including logginginterval and loggingduration in the RRC message, i.e., LoggedMeasurementConfiguration, from the network. A timer (T330) is started at the UE upon receiving the configurations and set to loggingduration (10 min-120 min). The UE in some embodiments shall perform periodical MDT logging with the interval set to logginginterval (1.28 s-61.44 s) when the UE is in RRC_IDLE. An example of the MDT logging is shown in FIG. 3.

For event triggered Logged MDT, the UE in some embodiments receives eventType and logginginterval from the network. The UE logs the measurement reports at every logging interval if the event configured in eventType is satisfied. A Rel-16 UE that supports NR logged MDT configuration can be configured with one amongst two different events. One of them is associated to logging of measurements when the UE enters the any cell selection state and the other when the UE's serving cell quality is below a threshold.

Some embodiments herein address challenges in this context. When the operators start to deploy the NTN to provide ubiquitous coverage, then, ideally, they would like to ensure that the UEs continue to camp on the terrestrial network (TN) when there is coverage from the TN and use the NTN when there is no coverage from the TN. This would ensure that the limitations due to the connectivity with NTN (e.g., larger delay) could be avoided when TN coverage is available.

While doing so, the operator might want to build the coverage maps of the TN and NTN and the relation between the two. Heretofore, there is no possibility to enable a logged MDT procedure involving an NTN node in an efficient way.

Certain aspects of the disclosure and their embodiments may provide solutions to these or other challenges. Some embodiments herein provide MDT logging related enhancements associated to the deployments involving NTN. The logging may be performed by the UE in any RRC state, e.g., Idle state, inactive state or connective state.

Some embodiments herein propose the following different logged measurements associated to NTN, as examples of the content 14C of an MDT measurement report 14 in FIG. 1.

In one embodiment, the UE logs whether the serving cell is a TN cell or an NTN cell. The logged information may comprise one or more of an indicator specific to NTN or TN. Alternatively or additionally, the logged information may comprise one or more parameters related to frequency of the cell specific to NTN or TN, (e.g., band number, frequency channel number, etc.).

In another embodiment, the UE logs information on Tracking area List TrackingAreaList associated to an NTN cell. Alternatively or additionally, the UE logs each List the UE reads while camping on an NTN cell. In this regard, an NTN LEO Earth moving cell has a list of tracking areas it broadcasts and the list is updated as the cell moves on Earth.

In yet another embodiment, the logged information includes location information being logged mandatorily while being served by an NTN cell. This location information could be one or more of coarse location information or fine location information available at the UE at the time of logging.

Alternatively or additionally, the logged information may include location information being logged mandatorily while being served by a TN cell, but the UE is a threshold/offset closer to an NTN cell reference location that is configured. Note that the location threshold may also be expressed with respect to any reference location, thus depending how it is expressed UE may be “closer” or “further away” from the threshold. The idea here is to be in an area where location-wise the UE potentially can be served also by an NTN network.

In another embodiment, the UE may alternatively or additionally log one or more of NTN related parameters, like ephemeris data, obtained in the serving cell. NTN-related parameters may include any NTN-related parameter broadcasted in NTN-specific System Information (SI), whether this is an NTN-specific System Information Block (SIB) or in an existing SIB like SIB1.

In some embodiments, for example, the UE logs a parameter related to “time left to be served” by an NTN LEO Earth fixed cell. In such scenario, a cell stops serving a geographical area when the inclination angle is low enough and the satellite switches the feeder link from one ground station to another. Alternatively or additionally, logging a parameter related to the UE's current time is optional together with logging of a parameter related to “time left to be served”. Alternatively or additionally, the UE may log a parameter ‘time to stop’ associated to NTN LEO Earth fixed cell, i.e., this is the absolute time when the logged LEO earth fixed cell has indicated that it will stop serving that area.

In some embodiments, the UE logs information on whether the previous serving cell before entering any cell selection state was an NTN cell or a TN cell. For example, the UE, upon entering any cell selection state for a certain NTN network type, may log the last serving cell of this network type, and the measurement results of the neighbouring TN serving cells (and of other neighbouring cells of a different NTN network type) as measured at the moment of entering any cell selection state for the concerned NTN network type. Additionally, the measurement results of the neighbouring TN serving cells (or neighbouring serving cells of different NTN network types) may be logged periodically, since the UE enters any cell selection state for the concerned NTN network type.

Similarly, in some embodiments, the UE upon entering any cell selection state for the TN, may log the last serving cell of the TN and the measurement results of any neighbouring NTN serving cell as measured at the moment of entering any cell selection state for the TN. Additionally, the measurement results of the any neighbouring NTN serving cell may be logged periodically, since the UE enters any cell selection state for the TN network.

Alternatively or additionally, the UE may log information on whether the first serving cell after coming back to camped normally state from any cell selection state, is an NTN cell or a TN cell.

In other embodiments, the UE may log an indication of whether the UE has coverage from the NTN or not while being served by a TN cell, i.e., if the UE is camping on a TN cell and if the UE is unable to detect any cells on the NTN related frequencies, then the UE includes an indicator in the MDT report that the UE was out of coverage of the NTN.

Alternatively or additionally, the UE may log an indication of whether the UE has coverage from the TN or not while being served by an NTN cell, i.e., if the UE is camping on an NTN cell and if the UE is unable to detect any cells on the TN related frequencies, then the UE includes an indicator in the MDT report that the UE was out of coverage of the TN.

In some embodiments, the UE logs a timing advance (TA) as computed by the UE based on the ephemeris data. The UE may for example compute the coarse timing advance value based on the ephemeris data and this computed timing advance value is logged. This timing advance value could be the initial TA that the UE uses for accessing an NTN cell, or it may be a more accurate TA value that the UE uses while in connected mode. Or, the timing advance value could be an offset to a timing advance value. In one embodiment, the related parameter name is K_offset and the UE may be logging K_offset and reporting it. Or, in some embodiments, the UE derives a value related to K_offset or a TA value, and logs and reports such a derived value.

In some embodiments, the UE logs a type of cell ranking criterion (e.g., location based or RSRP/RSRQ based) used by the UE for cell reselection. The cell ranking methodology used for the NTN could be different from the TN, i.e., in NTN a location-based cell reselection ranking could be configured by the network. Therefore, the serving cell of the UE is dependent on such a ranking criterion. Thus, the UE in some embodiments logs whether it has used the locationObased cell reselection criterion or measurement quantity (e.g., RSRP, RSRQ) based cell reselection criterion.

In some embodiments, the UE logs the duration of the NTN cell coverage time which is the duration of time for which the UE was in this coverage area of the NTN cell.

In other embodiments, the UE alternatively or additionally logs the predicted duration of the NTN cell coverage which is the outcome of the prediction by the UE based on the assistance information (e.g., ephemeris data).

In one or more embodiments, the UE logs trajectory-related information of the NTN cell.

In some embodiments, the UE logs any combination of the above, i.e., the UE may include more than one of the above at the time of logging, which would give further insights into the relation between the logged values. For example, the UE may include the detailed location information and an indication that the UE is out of coverage of NTN cell.

Generally, then, some embodiments herein include a method by a wireless device, comprising: (i) Receiving a logged MDT configuration from a first network node; (ii) Logging of first set of measurements associated to an NTN node; (iii) Transitioning to RRC connected mode in a second network node; and (iv) Transmitting the logged measurements to the second network node.

In some embodiments, the first set of measurements comprise one or more of: (1) The UE logs whether the serving cell is a TN cell or an NTN cell; (2) The UE logs whether the neighbor cell is a TN cell or an NTN cell; (3) Location information being logged mandatorily while being served by an NTN cell; (4) Further logging of one or more of NTN related parameters like ephemeris data obtained in the serving cell; (5) Logging of information on whether the previous serving cell before entering any cell selection state was an NTN cell or a TN cell

Certain embodiments may provide one or more of the following technical advantage(s). Some embodiments allow the NTN specific measurement collection, thus increasing the efficiency of building the NTN specific coverage maps and/or identifying coverage transition patterns between TN and NTN nodes/cells.

The following embodiments provide methods related to NTN specific logged MDT report contents, as examples of the content of an MDT measurement report 14 in FIG. 1 when the MDT measurements reported are logged MDT measurements.

In one embodiment, if the UE is configured with logged MDT, then the UE includes an indicator in the MDT results that indicates whether the currently camping cell is a TN cell or an NTN cell. The UE may acquire the indicator by acquiring system information of the cell, e.g., by acquiring the SIB, etc. In some exemplary implementation, NTN cells may operate on frequencies which use numbering schemes different than those used for frequencies operating TN cells. Examples of parameters related to frequency numbering schemes or simply frequency related information are frequency band number (e.g., band number s1, s2, etc., for NTN cell), frequency channel number (e.g., Absolute Radio Frequency Channel Number, ARFCN, number of the frequency of the cell), channel raster number, synchronization raster number, etc. The channel raster number determines a point in frequency which contains the channel bandwidth (BW) of the cell, e.g., lower edge, upper edge, or center of the channel BW in frequency. The synchronization raster number determines a point in frequency which contains the synchronization signals such as Synchronization Signal Block (SSB), e.g., lower edge, upper edge, or center of the SSB in frequency. Therefore, as an example, the indication whether the currently camping cell is a TN cell or an NTN cell may comprise any one or more frequency related information associated with the cell. For example, the NTN cell may operate on a NTN band using band numbering range from s1, s2, . . . etc. On the other hand, the TN cell may operate on a TN band using band numbering range from n1, n2, . . . etc. This aids the operator to quickly sort the NTN specific logs from the TN specific logs and thus helping in TN-specific or NTN-specific coverage map build up in a faster manner.

An example implementation of such an embodiment is given below. In this example, when the UE is camping in a TN cell, the UE sets the cellType to TN and when the UE is camping in an NTN cell, the UE sets the cellType to NTN.

| LogMeasReport-r16 ::= | SEQUENCE { | |
|---|---|---|
| absoluteTimeStamp-r16 | AbsoluteTimeInfo-r16, | |
| traceReference-r16 | TraceReference-r16, | |
| traceRecordingSessionRef-r16 | OCTET STRING (SIZE (2)), | |
| tce-Id-r16 | OCTET STRING (SIZE (1)), | |
| logMeasInfoList-r16 | LogMeasInfoList-r16, | |
| logMeasAvailable-r16 | ENUMERATED {true} | OPTIONAL, |
| logMeasAvailableBT-r16 | ENUMERATED {true} | OPTIONAL, |
| logMeasAvailableWLAN-r16 | ENUMERATED {true} | OPTIONAL, |
| ... | | |
| } | | |
| LogMeasInfoList-r16 ::= | SEQUENCE (SIZE (1..maxLogMeasReport-r16)) OF | |
| | LogMeasInfo-r16 | |
| LogMeasInfo-r16 ::= | SEQUENCE { | |
| locationInfo-r16 | LocationInfo-r16 | OPTIONAL, |
| relativeTimeStamp-r16 | INTEGER (0..7200), | |
| servCellIdentity-r16 | CGI-Info-Logging-r16 | OPTIONAL, |
| measResultServingCell-r16 | MeasResultServingCell-r16 | OPTIONAL, |
| measResultNeighCells-r16 | SEQUENCE { | |
| measResultNeighCellListNR | MeasResultListLogging2NR-r16 | OPTIONAL, |
| measResultNeighCellListEUTRA | MeasResultList2EUTRA-r16 | OPTIONAL |

},

| | | |
|---|---|---|
| anyCellSelectionDetected-r16 | ENUMERATED {true} | OPTIONAL, |

...
}

| | |
|---|---|
| MeasResultServingCell-r16 ::= | SEQUENCE { |
| resultsSSB-Cell | MeasQuantityResults, |
| resultsSSB | SEQUENCE{ |
| best-ssb-Index | SSB-Index, |
| best-ssb-Results | MeasQuantityResults, |
| numberOfGoodSSB | INTEGER (1..maxNrofSSBs-r16) |

} OPTIONAL,

| | | |
|---|---|---|
| cellType | ENUMERATED {TN, NTN} | OPTIONAL |

}

In another embodiment, if the UE is configured with logged MDT, then the UE includes an indicator in the MDT results associated to the neighbor cells if the neighbor cell is a TN cell or an NTN cell. This aids the operator to quickly sort the NTN specific logs from the TN specific logs and thus helping in TN-specific or NTN-specific coverage map build up in a faster manner.

An example implementation of such an embodiment is given below. In this example, two different possibilities are provided wherein by including the freqType, the UE can indicate if all the cells in this frequency are TN or NTN whereas by including cellType the UE can indicate if the specific cell on that frequency is a TN cell or an NTN cell. If freqType is set to TN, then all the neighbor cell measurements included as part of measResultListLoggingNR in the associated MeasResultLogging2NR belongs to TN and if freqType is set to NTN, then all the neighbor cell measurements included as part of measResultListLoggingNR in the associated MeasResultLogging2NR belongs to NTN. Similarly, if cellType is set to TN, then the corresponding neighbor cell is a TN cell and if cellType is set to NTN, then the corresponding neighbor cell is an NTN cell.

| LogMeasReport-r16 ::= | SEQUENCE { | |
|---|---|---|
| absoluteTimeStamp-r16 | AbsoluteTimeInfo-r16, | |
| traceReference-r16 | TraceReference-r16, | |
| traceRecordingSessionRef-r16 | OCTET STRING (SIZE (2)), | |
| tce-Id-r16 | OCTET STRING (SIZE (1)), | |
| logMeasInfoList-r16 | LogMeasInfoList-r16, | |
| logMeasAvailable-r16 | ENUMERATED {true} | OPTIONAL, |
| logMeasAvailableBT-r16 | ENUMERATED {true} | OPTIONAL, |
| logMeasAvailableWLAN-r16 | ENUMERATED {true} | OPTIONAL, |

...
}

| LogMeasInfoList-r16 ::= | SEQUENCE (SIZE (1..maxLogMeasReport-r16)) OF | |
|---|---|---|
| | LogMeasInfo-r16 | |
| LogMeasInfo-r16 ::= | SEQUENCE { | |
| locationInfo-r16 | LocationInfo-r16 | OPTIONAL, |
| relativeTimeStamp-r16 | INTEGER (0..7200), | |
| servCellIdentity-r16 | CGI-Info-Logging-r16 | OPTIONAL, |
| measResultServingCell-r16 | MeasResultServingCell-r16 | OPTIONAL, |
| measResultNeighCells-r16 | SEQUENCE { | |
| measResultNeighCellListNR | MeasResultListLogging2NR-r16 | OPTIONAL, |
| measResultNeighCellListEUTRA | MeasResultList2EUTRA-r16 | OPTIONAL |

},

| | | |
|---|---|---|
| anyCellSelectionDetected-r16 | ENUMERATED {true} | OPTIONAL, |

...
}

| MeasResultListLogging2NR-r16 ::= | SEQUENCE(SIZE (1..maxFreq)) OF | |
|---|---|---|
| | MeasResultLogging2NR-r16 | |
| MeasResultLogging2NR-r16 ::= | SEQUENCE { | |
| carrierFreq-r16 | ARFCN-ValueNR, | |
| measResultListLoggingNR-r16 | MeasResultListLoggingNR-r16, | |
| freqType | ENUMERATED {TN, NTN} | OPTIONAL |

}

| MeasResultListLoggingNR-r16 ::= | SEQUENCE (SIZE (1..maxCellReport)) OF | |
|---|---|---|
| | MeasResultLoggingNR-r16 | |
| MeasResultLoggingNR-r16 ::= | SEQUENCE { | |
| physCellId-r16 | PhysCellId, | |
| resultsSSB-Cell-r16 | MeasQuantityResults, | |
| numberOfGoodSSB-r16 | INTEGER (1..maxNrofSSBs-r16) | OPTIONAL, |
| cellType | ENUMERATED {TN, NTN} | OPTIONAL |

}

In another embodiment, if the UE is configured with logged MDT and if the UE is camping in an NTN cell, then the UE always includes the location information as it is mandatorily measured as part of NTN related operation. This enables the operator to establish the coverage map in terms of location information which is most valuable for identifying any location specific issues. An example implementation impact of this embodiment is provided below wherein the procedural text associated to MDT logging makes it mandatory for a UE camping in an NTN cell to log the location information.

In the above embodiments, the UE may further log location information (e.g., UE location such as geographical coordinates when the information is logged, etc.), timing related information (e.g., time instance when the information is logged), one or more measurement results of one or more TN and/or one or more NTN cells (e.g., RSRP, RSRQ, signal-to-interference-plus-noise-ratio, SINR, etc.) etc.

***************************

| | |
|---|---|
| 5.5a.3.2 | Initiation |

While T330 is running, the UE shall:

...

| 2> | when performing the logging: | |
|---|---|---|
| | 3> | set the relativeTimeStamp to indicate the elapsed time since the moment at which |
| | | the logged measurement configuration was received; |
| | 3> | if the UE is camping in a NTN cell: |

| 4> | set the commonLocationInfo to include the detailed location information; |
|---|---|
| 4> | if available, set the bt-LocationInfo to include the Bluetooth measurement results, |
| | in order of decreasing RSSI for Bluetooth beacons; |
| 4> | if available, set the wlan-LocationInfo to include the WLAN measurement results, |
| | in order of decreasing RSSI for WLAN APs; |
| 4> | if available, set the sensor-LocationInfo to include the sensor measurement |

| results as follows; | |
|---|---|
| 5> | if available, include the sensor-MeasurementInformation; |
| 5> | if available, include the sensor-MotionInformation; |

| | |
|---|---|
| 3> | else |

| | |
|---|---|
| 4> | if location information became available during the last logging interval, set the |

content of the locationInfo as in 5.3.3.7:

***************************

In another embodiment, if the UE is configured with logged MDT and if the UE is in any cell selection state, then the UE includes an indicator indicating whether the last serving cell before entering the any cell selection state was an NTN cell or a TN cell.

In another embodiment, if the UE is configured with logged MDT and if the UE comes back from any cell selection state to camped normally state then the UE includes an indicator indicating whether the current serving cell is an NTN cell or a TN cell.

In another embodiment, the UE is further configured to perform logging of the duration of the satellite coverage time (DT) or information related to the satellite coverage time for certain satellite (e.g., serving satellite). The UE may log the coverage time related information on an event triggered basis (e.g., upon performing a cell reselection to the NTN cell) or periodically. In some embodiments, the coverage time (DT) is characterized by or is function of one or more of the following parameters: (i) Starting reference time (Ts) as the moment when the coverage time for a satellite (e.g., serving satellite) starts; and/or (ii) ending reference time (Te) as the moment when the coverage time for a satellite (e.g., serving satellite) ends.

In one example, the UE autonomously calculates and predicts potential satellite coverage time related parameters or information, for example, based on UE acquisition of the satellite assistance information. The UE may acquire the satellite assistance information by receiving it periodically and/or based on a trigger. Examples of trigger are when the serving satellite changes, if the measured signal from the satellite at the UE changes by more than certain threshold, if the system information or assistance information changes, etc. For example, the UE can estimate satellite coverage time related information using satellite assistance information, e.g., satellite ephemeris information, or any other means, e.g., broadcast information.

In another example, the UE is alternatively or additionally configured to perform logging of the trajectory related information of the satellite. Examples of trajectory related information may comprise one or more of: speed or velocity of the satellite, satellite's position, orbit, propagation delay between the UE and the satellite, etc.

In the above embodiments, the UE may alternatively or additionally log location information (e.g., UE location such as geographical coordinates when the information is logged, etc.), timing related information (e.g., time instance when the information is logged), one or more measurement results of one or more TN and/or one or more NTN cells (e.g., RSRP, RSRQ, SINR, etc.) etc.

The UE may implement the above embodiments separately or in combination.

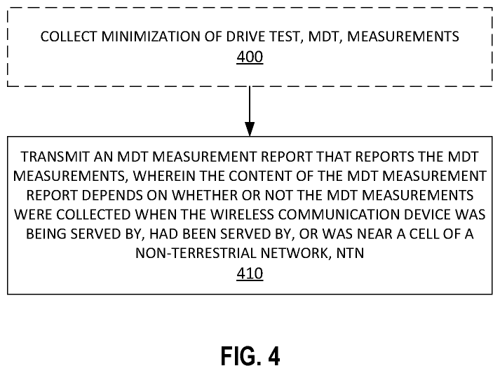

In view of the modifications and variations herein, FIG. 4 depicts a method performed by a wireless communication device 12 in accordance with particular embodiments. The method comprises transmitting an MDT measurement report 14 that reports collected MDT measurements (Block 410). The content 14C of the MDT measurement report 14 depends on whether or not the MDT measurements were collected when the wireless communication device 12 was being served by, had been served by, or was near a cell 20A of a non-terrestrial network, NTN 10A.

In some embodiments, the method further comprises collecting the MDT measurements (Block 400).

In some embodiments, the content 14C of the MDT measurement report 14 depends on whether or not the MDT measurements were collected when the wireless communication device 12 was being served by a cell 20A of an NTN 10A.

In some embodiments, the MDT measurement report 14 includes an indicator whose value indicates whether or not a cell serving the wireless communication device 12 when the MDT measurements were collected is a cell 20A of an NTN 10A.

In some embodiments, the content 14C of the MDT measurement report 14 depends on whether or not the MDT measurements were collected when the wireless communication device 12 was near a cell 20A of an NTN 10A.

In some embodiments, the MDT measurement report 14 includes an indicator whose value indicates whether or not a neighbor cell of a cell serving the wireless communication device 12 when the MDT measurements were collected is a cell 20A of an NTN 10A.

In some embodiments, the MDT measurement report 14 includes an indicator whose value indicates whether or not any neighbor cell of a cell serving the wireless communication device 12 when the MDT measurements were collected is a cell 20A of an NTN 10A.

In some embodiments, the MDT measurement report 14 includes an indicator whose value indicates whether or not the wireless communication device 12 had coverage from a cell 20A of an NTN 10A when the MDT measurements were collected from a cell of a terrestrial network. Alternatively, the MDT measurement report 14 includes an indicator whose value indicates whether or not the wireless communication device 12 had coverage from a cell of a terrestrial network when the MDT measurements were collected from a cell 20A of an NTN 10A.

In some embodiments, the content 14C of the MDT measurement report 14 depends on whether or not the MDT measurements were collected when the wireless communication device 12 had been served by a cell 20A of an NTN 10A. In one or more of these embodiments, the content 14C of the MDT measurement report 14 includes an indicator indicating whether, when the MDT measurements were collected, a last serving cell of the wireless communication device 12 before the wireless communication device 12 entered an any cell selection state is a cell 20A of an NTN 10A.

In some embodiments, the content 14C of the MDT measurement report 14 includes an indicator indicating whether, when the MDT measurements were collected, a cell that first served the wireless communication device 12 after the wireless communication device 12 exited an any cell selection state is a cell 20A of an NTN 10A.

In some embodiments, when the MDT measurements were collected when the wireless communication device 12 was served by a cell 20A of an NTN 10A, the MDT measurement report 14 always includes location information for the wireless communication device 12.

In some embodiments, the MDT measurements were collected when the wireless communication device 12 was being served by, had been served by, or was near a cell 20A of an NTN 10A. In this case, the MDT measurement report 14 reports a duration for which the wireless communication device 12 was, has been, or is predicted to be in coverage of a satellite 10A-1 serving the cell. Additionally or alternatively, the MDT measurement report 14 reports a type of cell ranking criterion used by the wireless communication device 12 for cell reselecting in the NTN 10A. Additionally or alternatively, the MDT measurement report 14 reports one or more characteristics of a satellite 10A-1 serving the cell. In one or more of these embodiments, the one or more characteristics include one or more of a speed or velocity of the satellite 10A-1, a position of the satellite 10A-1, an orbit of the satellite 10A-1, a propagation delay between the wireless communication device 12 and the satellite 10A-1, a timing advance for the satellite 10A-1.

In some embodiments, collecting MDT measurements comprises logging MDT measurements, and the MDT measurement report 14 is a logged MDT measurement report 14 that reports the logged MDT measurements. In one or more of these embodiments, logging MDT measurements comprises logging MDT measurements while the wireless communication device 12 is in a radio resource control, RRC idle mode or an RRC inactive mode, and transmitting the MDT measurement report 14 comprises transmitting the MDT measurement report 14 after transitioning from the RRC idle mode or the RRC inactive mode to an RRC connected state.

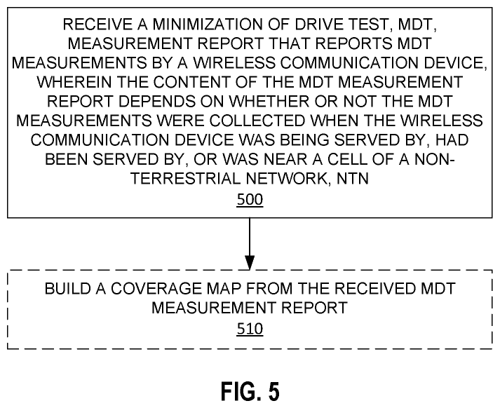

FIG. 5 depicts a method performed by a network node 16 configured for use in a wireless communication network in accordance with other particular embodiments. The method comprises receiving a minimization of drive test, MDT, measurement report 14 that reports MDT measurements by a wireless communication device 12 (Block 500). The content 14C of the MDT measurement report 14 depends on whether or not the MDT measurements were collected when the wireless communication device 12 was being served by, had been served by, or was near a cell 20A of a non-terrestrial network, NTN 10A.

In some embodiments, the method further comprises building a coverage map from the received MDT measurement report 14 (Block 510).

In some embodiments, the content 14C of the MDT measurement report 14 depends on whether or not the MDT measurements were collected when the wireless communication device 12 was being served by a cell 20A of an NTN 10A.

In some embodiments, the MDT measurement report 14 includes an indicator whose value indicates whether or not a cell serving the wireless communication device 12 when the MDT measurements were collected is a cell 20A of an NTN 10A.

In some embodiments, the content 14C of the MDT measurement report 14 depends on whether or not the MDT measurements were collected when the wireless communication device 12 was near a cell 20A of an NTN 10A.

In some embodiments, the MDT measurement report 14 includes an indicator whose value indicates whether or not a neighbor cell of a cell serving the wireless communication device 12 when the MDT measurements were collected is a cell 20A of an NTN 10A.

In some embodiments, the MDT measurement report 14 includes an indicator whose value indicates whether or not any neighbor cell of a cell serving the wireless communication device 12 when the MDT measurements were collected is a cell 20A of an NTN 10A.

In some embodiments, the MDT measurement report 14 includes an indicator whose value indicates whether or not the wireless communication device 12 had coverage from a cell 20A of an NTN 10A when the MDT measurements were collected from a cell of a terrestrial network. Alternatively, the MDT measurement report 14 includes an indicator whose value indicates whether or not the wireless communication device 12 had coverage from a cell of a terrestrial network when the MDT measurements were collected from a cell 20A of an NTN 10A.

In some embodiments, the content 14C of the MDT measurement report 14 depends on whether or not the MDT measurements were collected when the wireless communication device 12 had been served by a cell 20A of an NTN 10A. In one or more of these embodiments, the content 14C of the MDT measurement report 14 includes an indicator indicating whether, when the MDT measurements were collected, a last serving cell of the wireless communication device 12 before the wireless communication device 12 entered an any cell selection state is a cell 20A of an NTN 10A.

In some embodiments, the content 14C of the MDT measurement report 14 includes an indicator indicating whether, when the MDT measurements were collected, a cell that first served the wireless communication device 12 after the wireless communication device 12 exited an any cell selection state is a cell 20A of an NTN 10A.

In some embodiments, when the MDT measurements were collected when the wireless communication device 12 was served by a cell 20A of an NTN 10A, the MDT measurement report 14 always includes location information for the wireless communication device 12.

In some embodiments, the MDT measurements were collected when the wireless communication device 12 was being served by, had been served by, or was near a cell 20A of an NTN 10A. In this case, the MDT measurement report 14 reports a duration for which the wireless communication device 12 was, has been, or is predicted to be in coverage of a satellite 10A-1 serving the cell. Additionally or alternatively, the MDT measurement report 14 reports a type of cell ranking criterion used by the wireless communication device 12 for cell reselecting in the NTN 10A. Additionally or alternatively, the MDT measurement report 14 reports one or more characteristics of a satellite 10A-1 serving the cell. In one or more of these embodiments, the one or more characteristics include one or more of a speed or velocity of the satellite 10A-1, a position of the satellite 10A-1, an orbit of the satellite 10A-1, a propagation delay between the wireless communication device 12 and the satellite 10A-1, a timing advance for the satellite 10A-1.

In some embodiments, the MDT measurement report 14 is a logged MDT measurement report 14 that reports MDT measurements as logged by the wireless communication device 12. In one or more of these embodiments, the MDT measurement report 14 is a logged MDT measurement report 14 that reports MDT measurements as logged by the wireless communication device 12 in a radio resource control, RRC idle mode or an RRC inactive mode, and the MDT measurement report 14 is received from the wireless communication device 12 while the wireless communication device 12 is in an RRC connected state.

Embodiments herein also include corresponding apparatuses. Embodiments herein for instance include a wireless communication device 12 configured to perform any of the steps of any of the embodiments described above for the wireless communication device 12.

Embodiments also include a wireless communication device 12 comprising processing circuitry and power supply circuitry. The processing circuitry is configured to perform any of the steps of any of the embodiments described above for the wireless communication device 12. The power supply circuitry is configured to supply power to the wireless communication device 12.

Embodiments further include a wireless communication device 12 comprising processing circuitry. The processing circuitry is configured to perform any of the steps of any of the embodiments described above for the wireless communication device 12. In some embodiments, the wireless communication device 12 further comprises communication circuitry.

Embodiments further include a wireless communication device 12 comprising processing circuitry and memory. The memory contains instructions executable by the processing circuitry whereby the wireless communication device 12 is configured to perform any of the steps of any of the embodiments described above for the wireless communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 16 configured to perform any of the steps of any of the embodiments described above for the network node 16.

Embodiments also include a network node 16 comprising processing circuitry and power supply circuitry. The processing circuitry is configured to perform any of the steps of any of the embodiments described above for the network node 16. The power supply circuitry is configured to supply power to the network node 16.

Embodiments further include a network node 16 comprising processing circuitry. The processing circuitry is configured to perform any of the steps of any of the embodiments described above for the network node 16. In some embodiments, the network node 16 further comprises communication circuitry.

Embodiments further include a network node 16 comprising processing circuitry and memory. The memory contains instructions executable by the processing circuitry whereby the network node 16 is configured to perform any of the steps of any of the embodiments described above for the network node 16.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

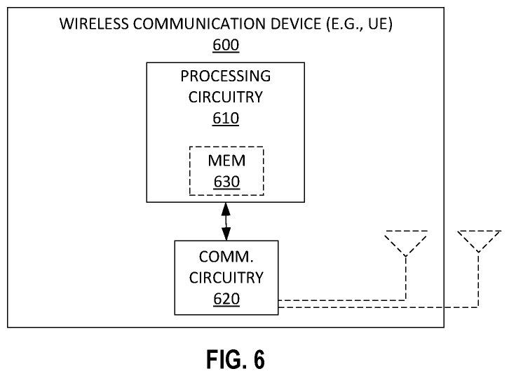

FIG. 6 for example illustrates a wireless communication device 12 as implemented in accordance with one or more embodiments. As shown, the wireless communication device 12 includes processing circuitry 610 and communication circuitry 620. The communication circuitry 620 (e.g., radio circuitry) is configured to transmit and/or receive information to and/or from one or more other nodes, e.g., via any communication technology. Such communication may occur via one or more antennas that are either internal or external to the wireless communication device 12. The processing circuitry 610 is configured to perform processing described above, e.g., in FIG. 4, such as by executing instructions stored in memory 630. The processing circuitry 610 in this regard may implement certain functional means, units, or modules.

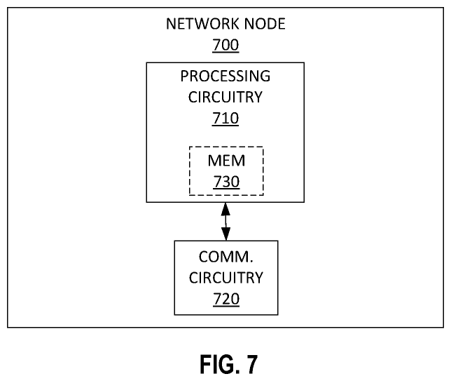

FIG. 7 illustrates a network node 16 as implemented in accordance with one or more embodiments. As shown, the network node 16 includes processing circuitry 710 and communication circuitry 720. The communication circuitry 720 is configured to transmit and/or receive information to and/or from one or more other nodes, e.g., via any communication technology. The processing circuitry 710 is configured to perform processing described above, e.g., in FIG. 5, such as by executing instructions stored in memory 730. The processing circuitry 710 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

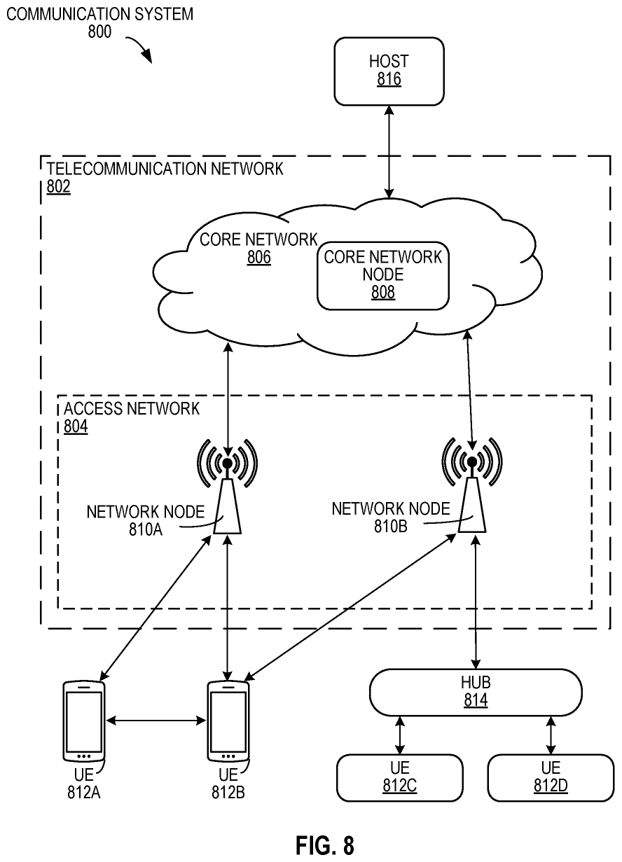

FIG. 8 shows an example of a communication system 800 in accordance with some embodiments.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3rd Generation Partnership Project (3GPP) access node or non-3GPP access point. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

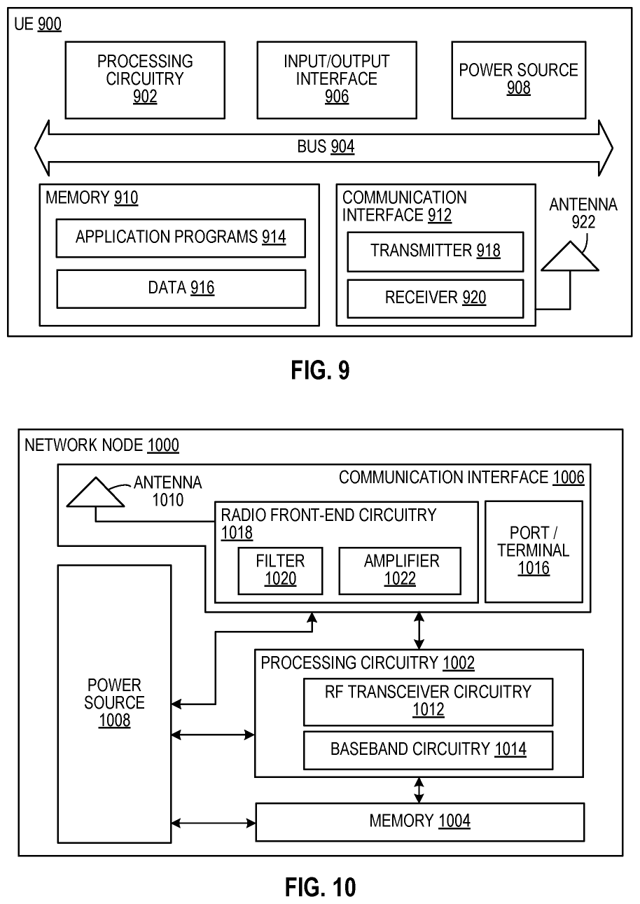

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

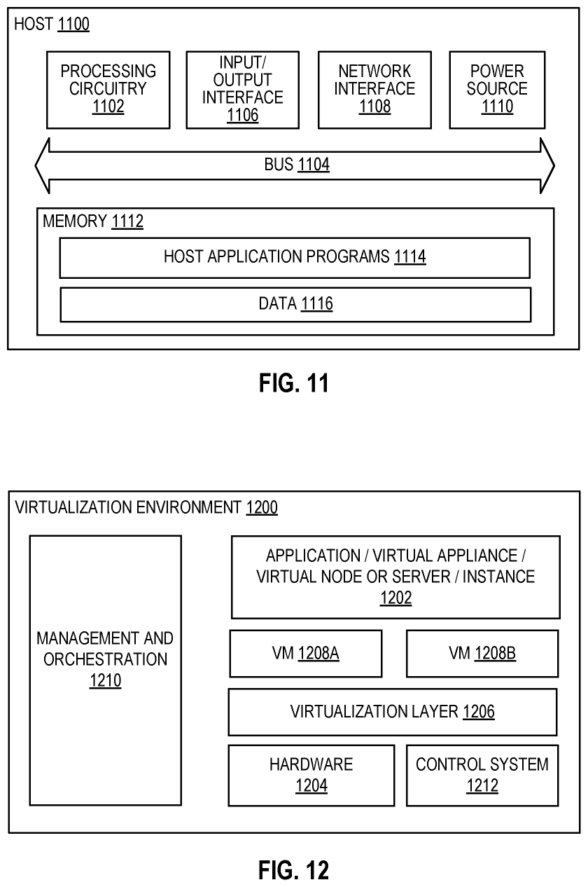

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

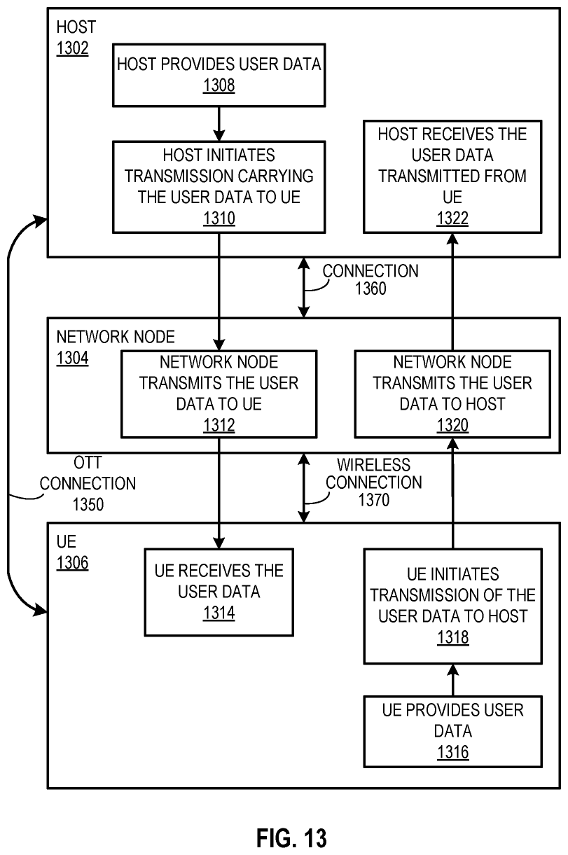

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the present disclosure will come to mind to one skilled in the art having the benefit of the teachings presented in the foregoing descriptions and the associated drawings. Therefore, it is to be understood that the present disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a wireless communication device, the method comprising: collecting minimization of drive test, MDT, measurements; and
   transmitting an MDT measurement report that reports the MDT measurements, wherein the content of the MDT measurement report depends on whether or not the MDT measurements were collected when the wireless communication device was being served by, had been served by, or was near a cell of a non-terrestrial network, NTN.
A2. The method of embodiment A1, wherein the content of the MDT measurement report depends on whether or not the MDT measurements were collected when the wireless communication device was being served by a cell of an NTN.
A3. The method of any of embodiments A1-A2, wherein the MDT measurement report includes an indicator whose value indicates whether or not a cell serving the wireless communication device when the MDT measurements were collected is a cell of an NTN.
A4. The method of any of embodiments A1-A3, wherein the content of the MDT measurement report depends on whether or not the MDT measurements were collected when the wireless communication device was near a cell of an NTN.
A5. The method of any of embodiments A1-A4, wherein the MDT measurement report includes an indicator whose value indicates whether or not a neighbor cell of a cell serving the wireless communication device when the MDT measurements were collected is a cell of an NTN.
A6. The method of any of embodiments A1-A4, wherein the MDT measurement report includes an indicator whose value indicates whether or not any neighbor cell of a cell serving the wireless communication device when the MDT measurements were collected is a cell of an NTN.
A7. The method of any of embodiments A1-A6, wherein the MDT measurement report includes:

an indicator whose value indicates whether or not the wireless communication device had coverage from a cell of an NTN when the MDT measurements were collected from a cell of a terrestrial network; or an indicator whose value indicates whether or not the wireless communication device had coverage from a cell of a terrestrial network when the MDT measurements were collected from a cell of an NTN.
A8. The method of any of embodiments A1-A7, wherein the content of the MDT measurement report depends on whether or not the MDT measurements were collected when the wireless communication device had been served by a cell of an NTN.
A9. The method of embodiment A8, wherein the content of the MDT measurement report includes an indicator indicating whether, when the MDT measurements were collected, a last serving cell of the wireless communication device before the wireless communication device entered an any cell selection state is a cell of an NTN.
A10. The method of any of embodiments A1-A9, wherein the content of the MDT measurement report includes an indicator indicating whether, when the MDT measurements were collected, a cell that first served the wireless communication device after the wireless communication device exited an any cell selection state is a cell of an NTN.
A11. The method of any of embodiments A1-A10, wherein, when the MDT measurements were collected when the wireless communication device was served by a cell of an NTN, the MDT measurement report always includes location information for the wireless communication device.
A12. The method of any of embodiments A1-A11, wherein the MDT measurements were collected when the wireless communication device was being served by, had been served by, or was near a cell of an NTN, wherein the MDT measurement report reports:
a duration for which the wireless communication device was, has been, or is predicted to be in coverage of a satellite serving the cell; and/or a type of cell ranking criterion used by the wireless communication device for cell reselecting in the NTN; and/or one or more characteristics of a satellite serving the cell.
A13. The method of embodiment A12, wherein the one or more characteristics include one or more of a speed or velocity of the satellite, a position of the satellite, an orbit of the satellite, a propagation delay between the wireless communication device and the satellite, a timing advance for the satellite.
A14. The method of any of embodiments A1-A13, wherein collecting MDT measurements comprises logging MDT measurements, and wherein the MDT measurement report is a logged MDT measurement report that reports the logged MDT measurements.
A15. The method of embodiment A14, wherein logging MDT measurements comprises logging MDT measurements while the wireless communication device is in a radio resource control, RRC idle mode or an RRC inactive mode, and wherein transmitting the MDT measurement report comprises transmitting the MDT measurement report after transitioning from the RRC idle mode or the RRC inactive mode to an RRC connected state.
AA. The method of any of the previous embodiments, further comprising:
   providing user data; and
   forwarding the user data to a host via the transmission to the network node.

### Group B Embodiments

B1. A method performed by a network node configured for use in a wireless communication network, the method comprising:
   receiving a minimization of drive test, MDT, measurement report that reports MDT measurements by a wireless communication device, wherein the content of the MDT measurement report depends on whether or not the MDT measurements were collected when the wireless communication device was being served by, had been served by, or was near a cell of a non-terrestrial network, NTN.
B2. The method of embodiment B1, wherein the content of the MDT measurement report depends on whether or not the MDT measurements were collected when the wireless communication device was being served by a cell of an NTN.
B3. The method of any of embodiments B1-B2, wherein the MDT measurement report includes an indicator whose value indicates whether or not a cell serving the wireless communication device when the MDT measurements were collected is a cell of an NTN.
B4. The method of any of embodiments B1-B3, wherein the content of the MDT measurement report depends on whether or not the MDT measurements were collected when the wireless communication device was near a cell of an NTN.
B5. The method of any of embodiments B1-B4, wherein the MDT measurement report includes an indicator whose value indicates whether or not a neighbor cell of a cell serving the wireless communication device when the MDT measurements were collected is a cell of an NTN.
B6. The method of any of embodiments B1-B4, wherein the MDT measurement report includes an indicator whose value indicates whether or not any neighbor cell of a cell serving the wireless communication device when the MDT measurements were collected is a cell of an NTN.
B7 The method of any of embodiments B1-B6, wherein the MDT measurement report includes:
   an indicator whose value indicates whether or not the wireless communication device had coverage from a cell of an NTN when the MDT measurements were collected from a cell of a terrestrial network; or
   an indicator whose value indicates whether or not the wireless communication device had coverage from a cell of a terrestrial network when the MDT measurements were collected from a cell of an NTN.
B8. The method of any of embodiments B1-B7, wherein the content of the MDT measurement report depends on whether or not the MDT measurements were collected when the wireless communication device had been served by a cell of an NTN.
B9. The method of embodiment B8, wherein the content of the MDT measurement report includes an indicator indicating whether, when the MDT measurements were collected, a last serving cell of the wireless communication device before the wireless communication device entered an any cell selection state is a cell of an NTN.
B10. The method of any of embodiments B1-B9, wherein the content of the MDT measurement report includes an indicator indicating whether, when the MDT measurements were collected, a cell that first served the wireless communication device after the wireless communication device exited an any cell selection state is a cell of an NTN.
B11. The method of any of embodiments B1-B10, wherein, when the MDT measurements were collected when the wireless communication device was served by a cell of an NTN, the MDT measurement report always includes location information for the wireless communication device.
B12. The method of any of embodiments B1-B11, wherein the MDT measurements were collected when the wireless communication device was being served by, had been served by, or was near a cell of an NTN, wherein the MDT measurement report reports:
   a duration for which the wireless communication device was, has been, or is predicted to be in coverage of a satellite serving the cell; and/or
   a type of cell ranking criterion used by the wireless communication device for cell reselecting in the NTN; and/or
   one or more characteristics of a satellite serving the cell.
B13. The method of embodiment B12, wherein the one or more characteristics include one or more of a speed or velocity of the satellite, a position of the satellite, an orbit of the satellite, a propagation delay between the wireless communication device and the satellite, a timing advance for the satellite.
B14. The method of any of embodiments B1-B13, wherein the MDT measurement report is a logged MDT measurement report that reports MDT measurements as logged by the wireless communication device.
B15. The method of embodiment B14, wherein the MDT measurement report is a logged MDT measurement report that reports MDT measurements as logged by the wireless communication device in a radio resource control, RRC idle mode or an RRC inactive mode, and wherein the MDT measurement report is received from the wireless communication device while the wireless communication device is in an RRC connected state.
B16. The method of any of embodiments B1-B15, further comprising building a coverage map from the received MDT measurement report.

BB. The method of any of the previous embodiments, further comprising:
obtaining user data; and
forwarding the user data to a host or a user equipment.

### Group C Embodiments

C1. A wireless communication device configured to perform any of the steps of any of the Group A embodiments.
C2. A wireless communication device comprising processing circuitry configured to perform any of the steps of any of the Group A embodiments.
C3. A wireless communication device comprising:
   communication circuitry; and
   processing circuitry configured to perform any of the steps of any of the Group A embodiments.
C4. A wireless communication device comprising:
   processing circuitry configured to perform any of the steps of any of the Group A embodiments; and
   power supply circuitry configured to supply power to the wireless communication device.
C5. A wireless communication device comprising:
   processing circuitry and memory, the memory containing instructions executable by the processing circuitry whereby the wireless communication device is configured to perform any of the steps of any of the Group A embodiments.
C6. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
C7. A computer program comprising instructions which, when executed by at least one processor of a wireless communication device, causes the wireless communication device to carry out the steps of any of the Group A embodiments.
C8. A carrier containing the computer program of embodiment C7, wherein the carrier is one of an electronic signal, optical signal, radio signal, or computer readable storage medium.
C9. A network node configured to perform any of the steps of any of the Group B embodiments.
C10. A network node comprising processing circuitry configured to perform any of the steps of any of the Group B embodiments.
C11. A network node comprising:
   communication circuitry; and
   processing circuitry configured to perform any of the steps of any of the Group B embodiments.
C12. A network node comprising:
   processing circuitry configured to perform any of the steps of any of the Group B embodiments;
   power supply circuitry configured to supply power to the network node.
C13. A network node comprising:
   processing circuitry and memory, the memory containing instructions executable by the processing circuitry whereby the network node is configured to perform any of the steps of any of the Group B embodiments.
C14. The network node of any of embodiments C9-C13, wherein the network node is a base station.
C15. A computer program comprising instructions which, when executed by at least one processor of a network node, causes the network node to carry out the steps of any of the Group B embodiments.
C16. The computer program of embodiment C14, wherein the network node is a base station.
C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
D2. The communication system of the previous embodiment further including the base station.
D3. The communication system of the previous 2 embodiments, further including the UE, wherein the UE is configured to communicate with the base station.
D4. The communication system of the previous 3 embodiments, wherein:
   the processing circuitry of the host computer is configured to execute a host application, thereby providing the user data; and
   the UE comprises processing circuitry configured to execute a client application associated with the host application.
D5. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
D6. The method of the previous embodiment, further comprising, at the base station, transmitting the user data.
D7. The method of the previous 2 embodiments, wherein the user data is provided at the host computer by executing a host application, the method further comprising, at the UE, executing a client application associated with the host application.
D8. A user equipment (UE) configured to communicate with a base station, the UE comprising a radio interface and processing circuitry configured to perform any of the previous 3 embodiments.
D9. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
D10. The communication system of the previous embodiment, wherein the cellular network further includes a base station configured to communicate with the UE.
D11. The communication system of the previous 2 embodiments, wherein:
   the processing circuitry of the host computer is configured to execute a host application, thereby providing the user data; and
   the UE's processing circuitry is configured to execute a client application associated with the host application.
D12. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
D13. The method of the previous embodiment, further comprising at the UE, receiving the user data from the base station.
D14. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
D15. The communication system of the previous embodiment, further including the UE.
D16. The communication system of the previous 2 embodiments, further including the base station, wherein the base station comprises a radio interface configured to communicate with the UE and a communication interface configured to forward to the host computer the user data carried by a transmission from the UE to the base station.
D17. The communication system of the previous 3 embodiments, wherein:
   the processing circuitry of the host computer is configured to execute a host application; and
   the UE's processing circuitry is configured to execute a client application associated with the host application, thereby providing the user data.
D18. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
D19. A method implemented in a communication system including a host computer, a base station and a user equipment (UE), the method comprising:
   at the host computer, receiving user data transmitted to the base station from the UE, wherein the UE performs any of the steps of any of the Group A embodiments.
D20. The method of the previous embodiment, further comprising, at the UE, providing the user data to the base station.
D21. The method of the previous 2 embodiments, further comprising:
   at the UE, executing a client application, thereby providing the user data to be transmitted; and
   at the host computer, executing a host application associated with the client application.
D22. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
D24. The communication system of the previous embodiment further including the base station.
D25. The communication system of the previous 2 embodiments, further including the UE, wherein the UE is configured to communicate with the base station.
D26. The communication system of the previous 3 embodiments, wherein:
   the processing circuitry of the host computer is configured to execute a host application;
   the UE is configured to execute a client application associated with the host application, thereby providing the user data to be received by the host computer.
D27. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
D28. The method of the previous embodiment, further comprising at the base station, receiving the user data from the UE.
D29. The method of the previous 2 embodiments, further comprising at the base station, initiating a transmission of the received user data to the host computer.

### REFERENCES

1. TR 38.832 v17.0.0 Study on enhancement of Radio Access Network (RAN) slicing, 3GPP
2. TS 37.320 v16.6.0 Universal Terrestrial Radio Access (UTRA) and Evolved Universal Terrestrial Radio Access (E-UTRA); Radio measurement collection for Minimization of Drive Tests (MDT); Overall description; Stage 2, 3GPP

1.-30. (canceled)

31. A method performed by a wireless communication device, the method comprising:
collecting minimization of drive test (MDT) measurements; and
transmitting an MDT measurement report that reports the MDT measurements, wherein the content of the MDT measurement report depends on whether or not the MDT measurements were collected when the wireless communication device was being served by, had been served by, or was near a cell of a non-terrestrial network (NTN).

32. The method of claim 31, wherein the content of the MDT measurement report depends on whether or not the MDT measurements were collected when the wireless communication device was:
being served by, or had been served by, a cell of an NTN; or
near a cell of an NTN.

33. The method of claim 31, wherein the MDT measurement report includes:
an indicator whose value indicates whether or not a cell serving the wireless communication device when the MDT measurements were collected is a cell of an NTN; and/or
an indicator indicating whether, when the MDT measurements were collected, a last serving cell of the wireless communication device before the wireless communication device entered an any cell selection state is a cell of an NTN; and/or
an indicator indicating whether, when the MDT measurements were collected, a cell that first served the wireless communication device after the wireless communication device exited an any cell selection state is a cell of an NTN.

34. The method of claim 31, wherein the MDT measurement report includes:
an indicator whose value indicates whether or not a neighbor cell of a cell serving the wireless communication device when the MDT measurements were collected is a cell of an NTN;
an indicator whose value indicates whether or not any neighbor cell of a cell serving the wireless communication device when the MDT measurements were collected is a cell of an NTN;
an indicator whose value indicates whether or not the wireless communication device had coverage from a cell of an NTN when the MDT measurements were collected from a cell of a terrestrial network; or
an indicator whose value indicates whether or not the wireless communication device had coverage from a cell of a terrestrial network when the MDT measurements were collected from a cell of an NTN.

35. The method of claim 31, wherein, when the MDT measurements were collected when the wireless communication device was served by a cell of an NTN, the MDT measurement report always includes location information for the wireless communication device.

36. The method of claim 31, wherein the MDT measurements were collected when the wireless communication device was being served by, had been served by, or was near a cell of an NTN, wherein the MDT measurement report reports:
a duration for which the wireless communication device was, has been, or is predicted to be in coverage of a satellite serving the cell; and/or
a type of cell ranking criterion used by the wireless communication device for cell reselecting in the NTN; and/or
one or more characteristics of a satellite serving the cell.

37. The method of claim 37, wherein the one or more characteristics include one or more of a speed or velocity of the satellite, a position of the satellite, an orbit of the satellite, a propagation delay between the wireless communication device and the satellite, a timing advance for the satellite.

38. A method performed by a network node configured for use in a wireless communication network, the method comprising:
receiving a minimization of drive test (MDT) measurement report that reports MDT measurements by a wireless communication device, wherein the content of the MDT measurement report depends on whether or not the MDT measurements were collected when the wireless communication device was being served by, had been served by, or was near a cell of a non-terrestrial network (NTN).

39. The method of claim 38, wherein the content of the MDT measurement report depends on whether or not the MDT measurements were collected when the wireless communication device was:
being served by, or had been served by, a cell of an NTN; or
near a cell of an NTN.

40. The method of claim 38, wherein the MDT measurement report includes:
an indicator whose value indicates whether or not a cell serving the wireless communication device when the MDT measurements were collected is a cell of an NTN; and/or
an indicator indicating whether, when the MDT measurements were collected, a last serving cell of the wireless communication device before the wireless communication device entered an any cell selection state is a cell of an NTN;
and/or an indicator indicating whether, when the MDT measurements were collected, a cell that first served the wireless communication device after the wireless communication device exited an any cell selection state is a cell of an NTN.

41. The method of claim 38, wherein the MDT measurement report includes:
an indicator whose value indicates whether or not a neighbor cell of a cell serving the wireless communication device when the MDT measurements were collected is a cell of an NTN;
an indicator whose value indicates whether or not any neighbor cell of a cell serving the wireless communication device when the MDT measurements were collected is a cell of an NTN;
an indicator whose value indicates whether or not the wireless communication device had coverage from a cell of an NTN when the MDT measurements were collected from a cell of a terrestrial network; or
an indicator whose value indicates whether or not the wireless communication device had coverage from a cell of a terrestrial network when the MDT measurements were collected from a cell of an NTN.

42. A wireless communication device comprising:
communication circuitry; and
processing circuitry configured to:
collect minimization of drive test (MDT) measurements; and
transmit an MDT measurement report that reports the MDT measurements, wherein the content of the MDT measurement report depends on whether or not the MDT measurements were collected when the wireless communication device was being served by, had been served by, or was near a cell of a non-terrestrial network (NTN).

43. The wireless communication device of claim 42, wherein the content of the MDT measurement report depends on whether or not the MDT measurements were collected when the wireless communication device was:
being served by, or had been served by, a cell of an NTN; or
near a cell of an NTN.

44. The wireless communication device of claim 42, wherein the MDT measurement report includes:
an indicator whose value indicates whether or not a cell serving the wireless communication device when the MDT measurements were collected is a cell of an NTN; and/or
an indicator indicating whether, when the MDT measurements were collected, a last serving cell of the wireless communication device before the wireless communication device entered an any cell selection state is a cell of an NTN; and/or
an indicator indicating whether, when the MDT measurements were collected, a cell that first served the wireless communication device after the wireless communication device exited an any cell selection state is a cell of an NTN.

45. The wireless communication device of claim 42, wherein the MDT measurement report includes:
an indicator whose value indicates whether or not a neighbor cell of a cell serving the wireless communication device when the MDT measurements were collected is a cell of an NTN;
an indicator whose value indicates whether or not any neighbor cell of a cell serving the wireless communication device when the MDT measurements were collected is a cell of an NTN;
an indicator whose value indicates whether or not the wireless communication device had coverage from a cell of an NTN when the MDT measurements were collected from a cell of a terrestrial network; or
an indicator whose value indicates whether or not the wireless communication device had coverage from a cell of a terrestrial network when the MDT measurements were collected from a cell of an NTN.

46. The wireless communication device of claim 42, when the MDT measurements were collected when the wireless communication device was served by a cell of an NTN, the MDT measurement report always includes location information for the wireless communication device.

47. The wireless communication device of claim 42, wherein the MDT measurements were collected when the wireless communication device was being served by, had been served by, or was near a cell of an NTN, wherein the MDT measurement report reports:
a duration for which the wireless communication device was, has been, or is predicted to be in coverage of a satellite serving the cell; and/or
a type of cell ranking criterion used by the wireless communication device for cell reselecting in the NTN; and/or
one or more characteristics of a satellite serving the cell.

48. The wireless communication device of claim 42, wherein the one or more characteristics include one or more of a speed or velocity of the satellite, a position of the satellite, an orbit of the satellite, a propagation delay between the wireless communication device and the satellite, a timing advance for the satellite.

49. A network node configured for use in a wireless communication network, the network node comprising:
communication circuitry; and
processing circuitry configured to receive, via the communication circuitry, a minimization of drive test (MDT) measurement report that reports MDT measurements by a wireless communication device, wherein the content of the MDT measurement report depends on whether or not the MDT measurements were collected when the wireless communication device was being served by, had been served by, or was near a cell of a non-terrestrial network (NTN).

50. The network node of claim 49, wherein the content of the MDT measurement report depends on whether or not the MDT measurements were collected when the wireless communication device was:
being served by, or had been served by, a cell of an NTN; or
near a cell of an NTN.
